(19) United States
(12) Patent Application Publication
(10) Pub. No.: US 2013/0022857 A1
(43) Pub. Date: Jan. 24, 2013

(54) Single Cell and Battery Having a Plurality of Single Cells

(71) Applicants: Jens Meintschel, Bernsdorf (DE); Dirk Schroeter, Winnenden (DE)

(72) Inventors: Jens Meintschel, Bernsdorf (DE); Dirk Schroeter, Winnenden (DE)

(73) Assignee: DAIMLER AG, Stuttgart (DE)

(21) Appl. No.: 13/637,292

(22) PCT Filed: Dec. 10, 2010
(86) PCT No.: PCT/EP10/07558

§ 371 Date: Sep. 25, 2012

(30) Foreign Application Priority Data
Mar. 26, 2010 (DE) 102010012934.8

(51) Int. Cl. H01M 2/02; H01M 10/50

(52) U.S. Cl. 429/120

(57) ABSTRACT

A single cell with a cell housing is provided. The cell housing is formed from two housing side walls and an electrically insulating frame arranged between them. An electrochemically active stack is arranged inside the cell housing, of which electrodes of equal polarity are electrically conductively connected to each other to form a pole. The poles are electrically conductively connected to one of the housing side walls. At least one of the housing side walls is formed to extend completely over an edge region of the frame, wherein the projecting region forms a cooling element.

The invention relates to a single cell with a cell housing, wherein the cell housing is formed by two housing side walls and an electrically insulating frame arranged between them, wherein an electrochemically active electrode stack is arranged inside the cell housing, of which the electrodes of equal polarity are electrically conductively connected to each other to form a respective pole, wherein the poles are each electrically conductively connected to one of the housing side walls.

The invention further relates to a battery with a plurality of single cells arranged electrically in parallel and/or in series.

P810600/DE/1 (official file reference: 10 2007 036 849.8) describes a single cell for a battery with an electrode stack arranged within a cell housing and a method for production thereof. The individual electrodes, preferably electrode foils, are electrically conductively connected to current collector lugs, wherein at least electrodes of different polarity are separated from each other in an insulating way by a separator, preferably a separator foil. Current collector lugs of equal polarity are electrically conductively connected to each other to form a pole. The current collector lugs of a pole are pressed and/or welded electrically conductively to each other.

P810601/DE/1 (official file reference 10 2007 036 847.1) describes a single cell of a battery with electrodes, preferably electrode foils, arranged within a cell housing, wherein a current collector lug is electrically conductively arranged on each electrode, wherein at least electrodes of different polarity are separated from each other in an insulating way by a separator, preferably a separator foil, wherein the current collector lug is electrically conductively connected to a pole. Each pole is electrically conductively connected to an electrically conductive region of an outer side of the cell housing. The two regions of different polarity in question are electrically insulated from each other and pole lugs are arranged on the regions in question, which project standing freely from the cell housing.

Furthermore P810649/DE/1 (official file reference 10 2007 063 179.2) discloses a battery with a heat conducting plate, through which a cooling medium flows for tempering the battery, wherein the battery comprises a plurality of single cells arranged in parallel and/or in series with each other which are surrounded at least in areas by a cell housing and are connected in a heat conducting way to the heat conducting plate. At least one of the housing side walls of the cell housing thereby comprises in sections a side wall element going beyond the length of the respective single cell, which side wall element is angled in relation to the housing side wall in the direction towards the inside of the cell and forms at least one section of a housing wall arranged transversely with respect to a housing side wall.

It is an object of the invention to indicate a single cell which has been improved in relation to the prior art and a battery with a plurality of single cells arranged electrically in parallel and/or in series, with the aid of which improved and simplified cooling of the single cells can be achieved.

Having regard to the single cell the object is achieved according to the invention through the features indicated in claim 1 and having regard to the battery through the features indicated in claim 8.

Advantageous embodiments of the invention are the subject matter of the sub-claims.

The single cell comprises a cell housing which is formed from two housing side walls and an electrically insulating frame arranged between them, wherein an electrochemically active electrode stack is arranged inside the cell housing, of which the electrodes of equal polarity are electrically conductively connected to each other to form a respective pole, wherein the poles are electrically conductively connected to one of the housing side walls.

According to the invention at least one of the housing side walls is formed completely projecting over an edge region of the frame, wherein the projecting region forms a cooling element. In this way, simple and effective cooling of the single cell, in particular through direct impact with a cooling medium, such as e.g. air or a cooling liquid, is possible, so that an additional arrangement of a heat conducting plate can be omitted.

In order to achieve a further increase in the cooling capacity a cooling body is thermally coupled with the cooling element according to an advantageous development of the single cells according to the invention.

Alternatively or additionally the cooling element is configured in a meandering or wave form in its height extension so that an effective cooling surface of the cooling elements is enlarged and the cooling is thus improved.

The cooling element also preferably has swirl means, for example a roughened surface or guide elements, by means of which swirling of the cooling medium and thus an increased heat transfer between the single cell and the cooling medium can be achieved.

If cooling elements of both housing side walls are formed to completely project over the edge region of the frame a sealing element is expediently arranged on an end side of the frame arranged between the cooling elements of the housing side walls so that penetration of foreign substances, in particular dirt particles and moisture, is prevented.

In order to ensure a space-saving and easy to handle construction of the single cell the electrodes of the electrode stack are formed in particular from electrode foils and a separator foil is arranged between electrode foils of different polarity and electrode foils projecting over an edge region of the electrode stack are respectively brought together to form a current collector lug. The current collector lugs thereby advantageously form the poles of the electrode stack.

Furthermore two material recesses spaced apart from each other are incorporated into the frame to receive the current collector lugs so that the current collector lugs are simply electrically insulated from each other and securely held. The cell housing of the single cell is closed in a sealing manner against the penetration of foreign materials in particular by an at least partial melting of the frame and subsequent pressing of the housing side walls against the frame, wherein on account of the arrangement of the material recesses and the incorporation of the current collector lugs between the housing side walls and the material recesses no additional arrangement for electrical connection of the housing side walls to the current collector lugs is necessary. A length and width extension of the material recesses advantageously corresponds to at least the length and width extension of the current collector lugs and a height extension is as large as or smaller than the height extension of the current collector lugs stacked freely one on top of the other.

The battery according to the invention comprises a plurality of single cells arranged electrically in parallel and/or in series. Due to the projecting cooling elements of the single cells a cooling of the battery through direct impacting of the cooling elements with the cooling medium is possible in a simple and effective way. Due to the resulting possibility of omitting an additional heat conducting plate it is simpler to handle the battery and a low weight thereof is achieved. This is particularly advantageous when the battery is configured as a lithium ion battery for a vehicle, e.g as a battery for a vehicle with hybrid drive or a fuel cell vehicle, since a lower energy requirement is necessary for driving the vehicle due to the reduced weight of the battery.

A cover element is preferably arranged on a composite cell unit formed by the single cells on a side facing the projecting regions, wherein cooling channels are formed between the cooling elements of the single cells arranged adjacently which are laterally delimited by means of the cooling elements and on the side facing away from the composite cell unit by means of the housing cover. In the assembled state, i.e. in the closed state of the cover element, the cooling elements and the cover element advantageously form a guide element for guiding a cooling medium which facilitates optimised guiding of the cooling medium and thus optimised cooling of the battery.

A width and a length of the cover element thereby correspond in particular to a width and length of the composite cell unit.

According to a further development of the battery the cover element is formed from a flat side and two side wall elements, wherein the side wall elements are angled at two opposite ends of the flat side in relation to the flat side in the direction towards the composite cell unit and respectively extend in the assembled state parallel to the cooling elements of the housing side walls.

A height of the side wall elements preferably corresponds at least to a height of the cooling elements of the housing side walls or is larger than them.

At least one sealing element is also arranged on end sides of the frames respectively arranged between two cooling elements of the housing side walls of one of the single cells or adjacent single cells so that a penetration of foreign material or the cooling medium between the single cells is avoided. As a result corrosion of the housing side walls and an associated enlargement of a transition resistance between the housing side walls advantageously does not arise.

Exemplary embodiments of the invention are explained in greater detail below with the aid of the drawings, in which:

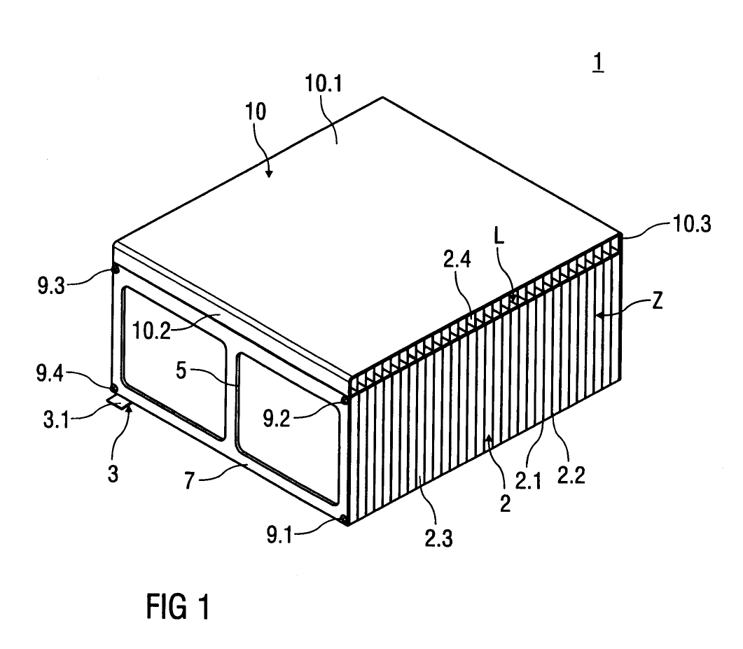

FIG. 1 shows schematically a battery with a plurality of single cells in a perspective view,

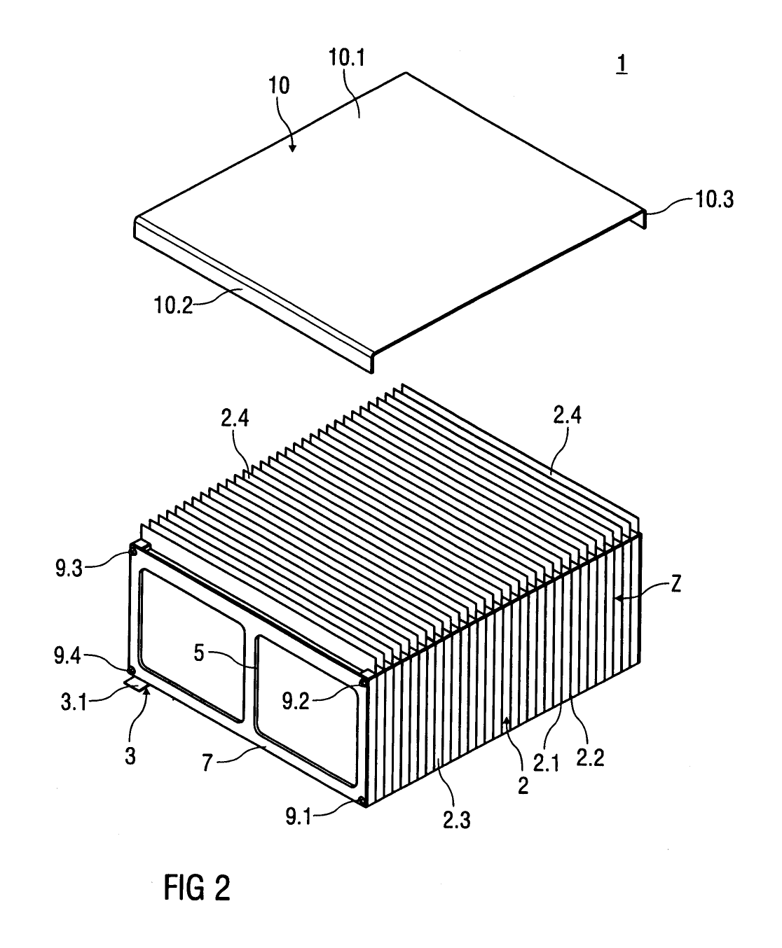

FIG. 2 schematically the battery according to FIG. 1 with the cover element removed in a perspective view,

FIG. 3 schematically a composite cell unit of the battery according to FIG. 1 in an exploded view,

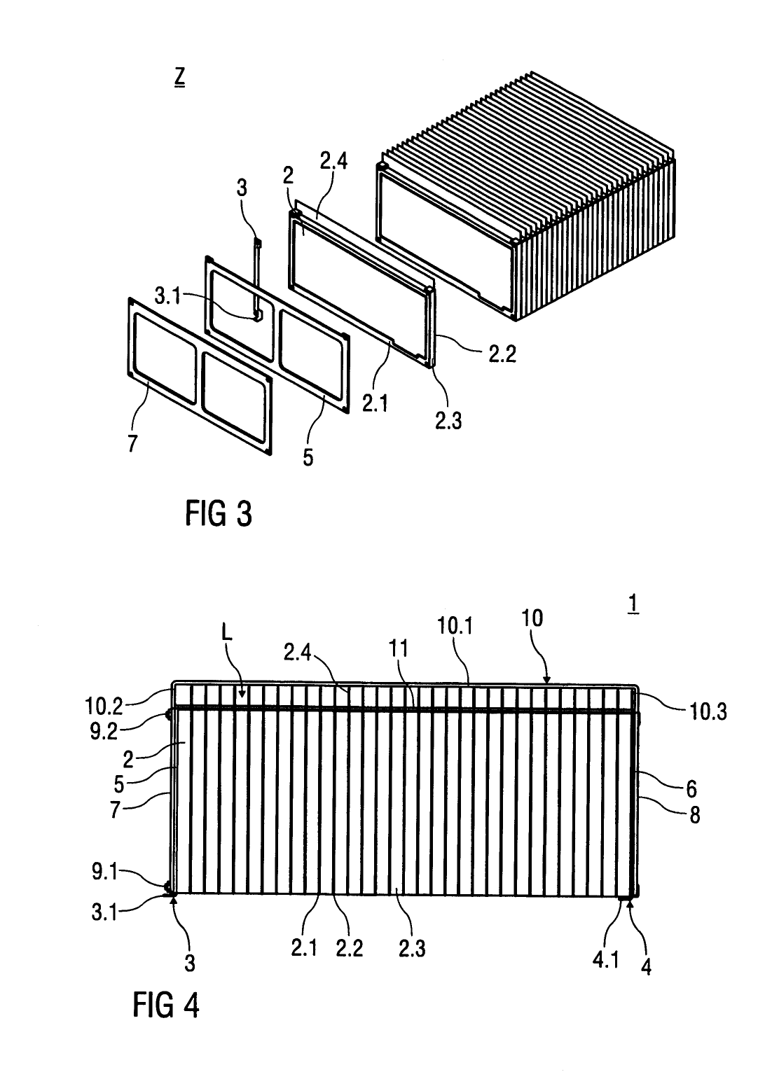

FIG. 4 schematically the battery according to FIG. 1 in a side view,

FIG. 5 schematically a detailed view of the battery according to FIG. 4,

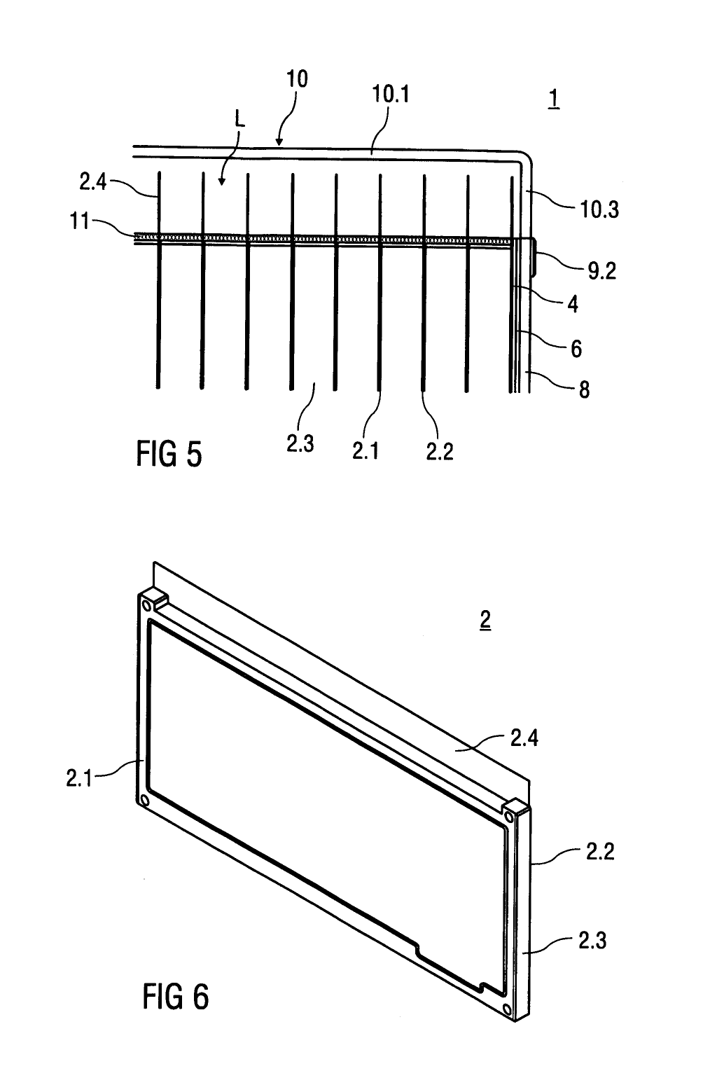

FIG. 6 schematically a single cell in a perspective view,

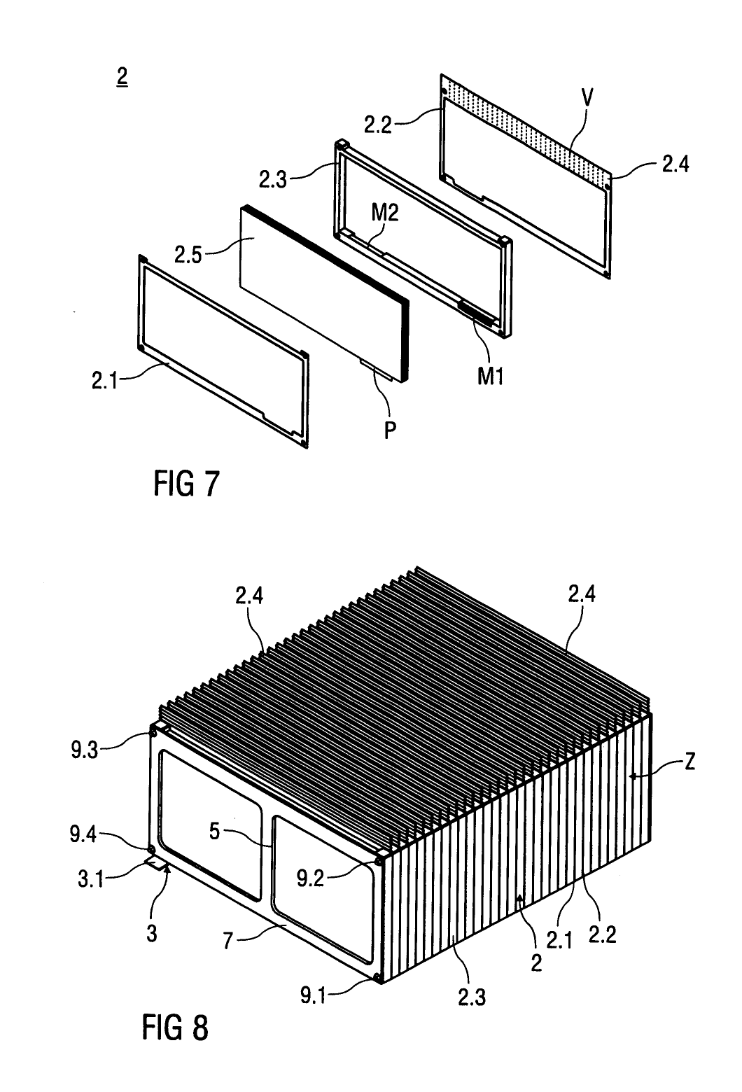

FIG. 7 schematically the single cell according to FIG. 6 in an exploded view,

FIG. 8 schematically a battery with the cover element removed in a perspective view, wherein cooling elements of the single cells are configured in wave form,

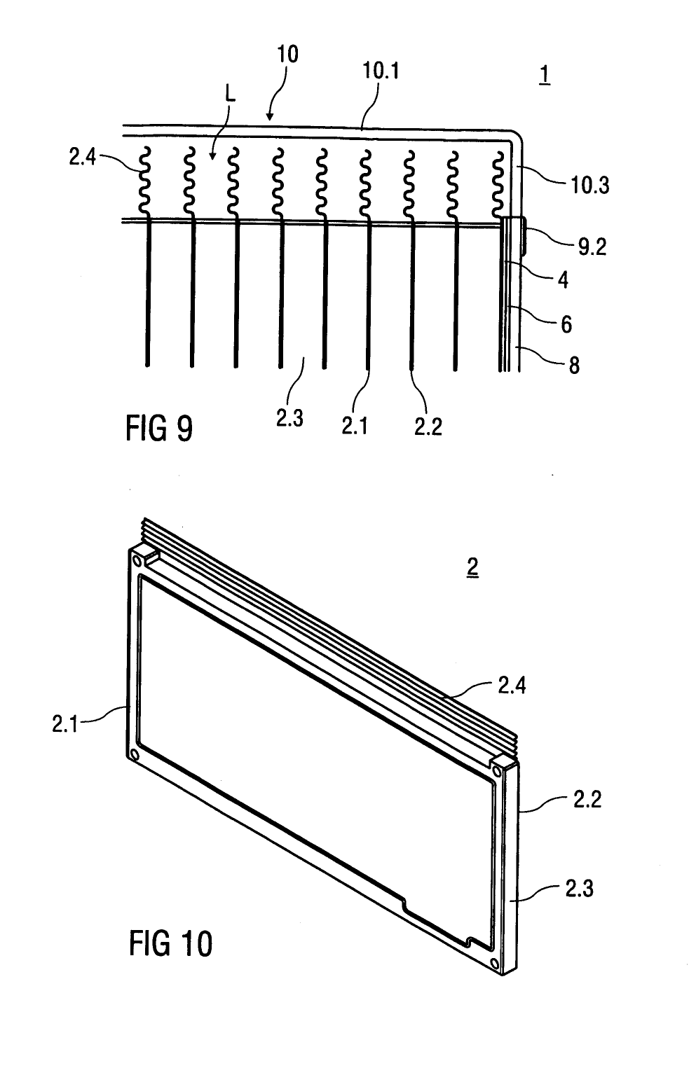

FIG. 9 schematically a detailed illustration of the battery according to FIG. 8 in a side view, and

FIG. 10 schematically a perspective view of a single cell with wave form cooling element.

Parts corresponding to each other are provided with the same reference numerals in all the figures.

FIGS. 1 to 5 show a battery 1 which is in particular a high-voltage lithium-ion battery for electric and/or hybrid vehicles or a composite cell unit Z of the battery 1 with a plurality of single cells 2 connected electrically with each other in different views.

The single cells 2 shown in more detail in FIGS. 6 and 7 are configured as so-called flat frame cells, of which the cell housing is formed from two housing side walls 2.1 and 2.2 and an electrically insulating frame 2.3, e.g. a plastic frame, arranged between them and extending around the edge.

In order to produce the battery 1 the single cells 2 are connected to each other electrically in series in the exemplary embodiment shown, wherein with this series arrangement an electrical connection of the single cells 2 is achieved through contact of the housing side walls 2.1, 2.2 of directly adjacent single cells 2.

For the mechanical formation of a composite cell unit Z consisting of the single cells 2, the single cells 2 are arranged one beside the other in the electric series arrangement. On the edge side, i.e. on the first and last single cell 2 of the composite cell unit Z, a respective high-voltage contact 3, 4 is arranged, wherein the high-voltage contacts 3, 4 are provided in particular for coupling the battery 1 with electric consumers and/or an on-board network of the vehicle (not shown in further detail). For the purpose of this coupling the high-voltage contacts 3, 4 respectively comprise an angled lug-like extension 3.1, 4.1 which serves as an electric connection contact.

A frame-like insulation element 5, 6 and a frame-like pressure plate 7, 8, a so-called pressure gland, are arranged on the edge side on the cell composite unit Z on the high-voltage contacts 3, 4.

Furthermore the single cells 2 are pressed by means of so-called tension rods 9.1 to 9.4 together with the high-voltage contacts 3, 4, the insulation elements 5, 6 and the pressure plates 7, 8 to form the composite cell unit Z in the longitudinal direction, i.e. horizontally to the length extension of the composite cell unit Z. The tension rods 9.1 to 9.4 are thereby guided according to the exemplary embodiment shown through the composite cell unit Z, i.e. on the edge side through the housing side walls 2.1, 2.2 and the frames 2.3 of the single cells 2, the high-voltage contacts 3, 4, the insulation elements 5, 6 and the pressure plates 7, 8. Alternatively the tension rods 9.1 to 9.4 are guided in a manner not shown in greater detail outside of the composite cell unit Z.

The insulation elements 5, 6 and the pressure plates 7, 8 thereby have in particular the same form, wherein due to the frame-like formation a low overall weight of the battery 1 is achieved. It follows from the arrangement of the insulation elements 5, 6 shown that both the pressure plates 5, 6 and the tension rods 9.1 to 9.4 are electrically insulated from the single cells 2.

In order to cool the single cells 2 and the battery formed by them according to the invention at least one of the housing side walls 2.1 or 2.2 of the respective single cell 2 is/are formed completely projecting over an edge region of the frame 2.3, wherein the projecting region forms a cooling element 2.4. In the embodiment shown a respective housing side wall 2.2. of the single cells 2 is formed projecting over the frame 2.3, wherein in the arrangement of the single cells 2 shown one beside the other upwardly open cooling channels are formed between the cooling elements 2.4 and extend parallel to each other and transversely to the longitudinal extension of the composite cell unit Z.

Alternatively, in a manner not shown in greater detail, the two housing side walls 2.1 and 2.2 are formed projecting over the frame 2.3 so that a respective cooling element 2.4 is formed on both housing side walls 2.1 and 2.2.

Furthermore a cover element 10 is arranged on the composite cell unit Z formed by the single cells 2 on a side facing the cooling elements 2.4. A width and length extension of the cover element 10 thereby corresponds to a width and length of the composite cell unit Z. This means that the cover element 10 covers—as shown in the illustrated embodiment—the composite cell unit Z completely.

The cover element 10 is thereby formed from a flat side 10.1 and two side wall elements 10.2 and 10.3, wherein the flat side 10.1 is arranged perpendicular to the height extension of the cooling elements 2.4, i.e. transversely to the composite cell unit Z. The side wall elements 10.2, 10.3 are angled at 90° at two opposite ends of the flat side 10.1 with respect to the flat side 10.1 in the direction towards the composite cell unit Z and each extend parallel to the cooling elements 2.4 of the housing side walls 2.2. A height of the side wall elements 10.2, 10.3 is greater than a height of the cooling elements 2.4 so that the cooling elements 2.4 and the flat side 10.1 of the cover element 10 are spaced apart from each other. Electrical short circuits between the single cells are thereby avoided.

In an embodiment of the cover element 10 not shown in further detail the height of the side wall elements 10.2, 10.3 corresponds to the height of the cooling elements 2.4. In this case with a metallic formation of the cover element 10 an electrically insulating material is arranged between the flat side 10.1 and the cooling elements 2.4 in order to avoid electric short circuits. Alternatively a complete formation of the cover element 10 from an electrically insulating material, for example plastic, is possible.

The cover element 10 is fastened by means of a force-locking, material-locking and/or shape-locking connection to the composite cell unit Z, wherein said force-locking, material-locking and/or shape-locking connection is formed through screwing, riveting, adhesion and/or welding. In the embodiment shown the cover element 10 is fastened to the pressure plates 7, 8, in particular being stuck.

The cooling elements 2.4 of the single cells 2 and the cover element 10 thus form in the assembled state of the battery 1, i.e. when the cover element 10 is placed on the composite cell unit Z, a guiding element L for guiding a cooling medium. The guiding element L can be impacted for example with air or a liquid cooling medium. Non-electrically conductive cooling oils such as transformer oil are hereby particularly suitable as a liquid cooling medium, whereby due to the direct impacting of the guide element L with the cooling medium a large heat output and subsequently an effective cooling can be realised.

In order to avoid entry of foreign bodies and in particular moisture between the single cells 2, according to FIG. 5 a sealing element 11 is placed on end sides of the frame 2.3 arranged between the cooling elements 2.4 of adjacent single cells 2, wherein the sealing element 11 is arranged in the exemplary embodiment shown as a casting compound enclosing all the end sides of the frame 2.3 facing the cover element 10. Alternatively an arrangement of individual seals for each cooling channel is also possible, wherein both the individual seals and also the sealing element 11 enclosing the plurality of end sides of the frames 2.3 of the single cells 2 can be formed from the casting compound, rubber or plastic.

FIGS. 6 and 7 show a single cell 2 in various illustrations. The single cell 2 is a flat frame cell, wherein a cell housing G is formed from the two housing side walls 2.1, 2.2 and the electrically insulating frame 2.3 arranged between them. Inside the cell housing G an electrochemically active electrode stack 2.5 is arranged, of which the electrodes of equal polarity are electrically conductively connected to each other to form a respective pole P, wherein the poles P are electrically conductively connected to one of the housing side walls 2.1, 2.2.

The electrodes of the electrode stack are thereby formed from electrode foils, wherein a separator foil is arranged between the electrode foils of different polarity and electrode foils of equal polarity projecting over an edge region of the electrode stack 2.5 are brought together to form a current collector lug. These current collector lugs form the poles of the electrode stack.

In order to fix the electrode stack 2.5 within the cell housing G the frame comprises two material recesses M1, M2 spaced apart from each other for receiving the current collector lugs. In order to close the single cells 2 and to produce an electric contact between the electrode stack 2.5 and the housing side walls 2.1, 2.2 the frame is melted at least on the surface on the areas facing the housing side walls 2.1, 2.2 and said housing side walls 2.1, 2.2. are subsequently joined under pressure to the frame 2.3. For this purpose the frame 2.3 is preferably formed from a thermoplastic material.

As a length and width extension of the material recesses M1, M2 advantageously at least corresponds to the length and width extension of the current collector lugs, i.e. of the poles P, and a height extension is as large as or smaller than the height extension of the current collector lugs stacked freely one on top of the other, on the one hand the electrical contact is simply produced between the poles P and the housing side walls 2.1, 2.2 and on the other hand the electrode stack 2.5 is securely held in the cell housing G. In addition the current collector lugs can be welded to the associated housing side wall 2.1, 2.2 so that a material-locking connection is produced between the poles P of the electrode stack 2.5 and the housing side walls 2.1, 2.2 which is characterised by a low electric transition resistance.

The single cell 2 shown comprises, in the region of the cooling element 2.4 which is formed by a formation of the housing side wall 2.2. projecting over the frame 2.3, swirl means V, with the aid of which swirling of the flow of the cooling medium within the cooling channels formed can be produced. This swirl results in turn in an enlargement of a heat transition between the cooling elements 2.4 and the cooling medium. The swirl means V are thereby formed for example by structures and/or strip elements incorporated on or in a surface of the cooling elements 2.4. The swirl means V thereby lead in particular to an increase in the roughness of the surface and/or to targeted guiding of the cooling medium on the surface of the cooling elements 2.4.

FIGS. 8 to 10 show a battery 1 in different views. The cooling elements 2.4 of the single cells 2 are thereby configured in wave-form so that a heat transfer surface is increased between the cooling elements 2.4 and the cooling medium. Alternatively further formations (not shown in greater detail), in particular meandering formations of the cooling elements 2.4, are provided in order to increase the effective heat transfer surface.

In a further development (not shown in further detail) cooling bodies are arranged alternatively or additionally on the cooling elements 2.4, wherein said cooling bodies are preferably formed so that the effective heat transfer surface is further enlarged and thus the heat output of the single cells 2 to the cooling medium is maximised.

1-15. (canceled)

16. A single cell, comprising:
a cell housing, wherein the cell housing has two housing side walls and an electrically insulating frame arranged between the two housing side walls; and
an electrochemically active electrode stack arranged inside the cell housing, of which electrodes of equal polarity are electrically conductively connected to each other to form a respective pole, wherein the poles are electrically conductively connected to one of the housing side walls,
wherein at least one of the housing side walls is configured to project completely over an edge region of the frame as a projecting region that is a cooling element.

17. The single cell according to claim 16, wherein a cooling body is thermally coupled with the cooling element of the respective housing side wall.

18. The single cell according to claim 16, wherein the cooling element is configured in a meandering or wave form.

19. The single cell according to claim 16, wherein the cooling element comprises swirl means.

20. The single cell according to claim 16, wherein cooling elements are formed to project on both housing side walls completely over the edge region of the frame, wherein a sealing element is arranged on an end side of the frame arranged between the cooling elements.

21. The single cell according to claim 16, wherein the electrodes of the electrode stack are formed from electrode foils and a separator foil is arranged between electrode foils of different polarity and electrode foils of equal polarity projecting over an edge region of the electrode stack are brought together to form a respective current collector lug, wherein current collector lugs form the poles of the electrode stack.

22. The single cell according to claim 21, wherein two material recesses that are spaced apart from each other and are configured to receive the current collector lugs are incorporated into the frame.

23. A battery, comprising:
a plurality of single cells arranged electrically in parallel or in series, each of the plurality of single cells comprising
a cell housing, wherein the cell housing has two housing side walls and an electrically insulating frame arranged between the two housing side walls; and
an electrochemically active electrode stack arranged inside the cell housing, of which electrodes of equal polarity are electrically conductively connected to each other to form a respective pole, wherein the poles are electrically conductively connected to one of the housing side walls,
wherein at least one of the housing side walls is configured to project completely over an edge region of the frame as a projecting region that is a cooling element.

24. The battery according to claim 23, wherein a cover element is arranged on a composite cell unit formed by the single cells on a side facing the cooling elements of each of the plurality of single cells so that cooling channels are formed between the cooling elements of adjacently arranged single cells, said cooling channels being delimited laterally by the cooling elements and on a side facing away from the composite cell unit by the housing cover.

25. The battery according to claim 24, wherein, in an assembled state, the cooling elements and the cover element form a guide element configured to guide a cooling medium.

26. The battery according to claim 24, wherein a width and a length of the cover element each respectively correspond to a width and a length of the composite cell unit.

27. The battery according to claim 24, wherein the cover element comprises a flat side and the two side wall elements, wherein said two side wall elements are angled at two opposite ends of the flat side in relation to the flat side in a direction towards the composite cell unit and in an assembled state extend parallel to the cooling elements of the housing side walls.

28. The battery according to claim 27, wherein a height of the side wall elements corresponds at least to a height of the cooling elements of the housing side walls.

29. The battery according to claim 23, wherein at least one sealing element is arranged on end sides of the frame arranged respectively between two cooling elements of the housing side walls of one of the single cells or adjacent single cells.

30. The battery according to claim 23, wherein the battery is a lithium-ion battery for a vehicle with hybrid drive or a fuel cell vehicle.
